(19) United States
(12) Patent Application Publication
(10) Pub. No.: US 2004/0194103 A1
(43) Pub. Date: Sep. 30, 2004

(54) Method and apparatus for downloading internet advertisements

(76) Inventors: Ji Wang, Shanghai (CN); Xiao Han, Shanghai (CN)

Correspondence Address: HARNESS, DICKEY & PIERCE, P.L.C., P.O. BOX 8910, RESTON, VA, 20195, US

(21) Appl. No.: 10/757,572

(22) Filed: Jan. 15, 2004

(30) Foreign Application Priority Data
Jan. 17, 2003 (CN) 03114947.2

(51) Int. Cl. G06F 9/46

(52) U.S. Cl. 718/100

(57) ABSTRACT

The present invention provides a method of downloading Internet advertisement, comprising steps of: downloading an Internet advertisement in a manner substantially unnoticeable to a user who browses a web page; after said Internet advertisement is completely downloaded, playing said Internet advertisement to said user. According to the present invention, large scale Internet advertisements are downloaded in a manner substantially unnoticeable to the user, and the user's browsing activities are not affected. More ways of expression become feasible in producing Internet advertisements to achieve the same effects as traditional TV advertisements.

### FIELD OF THE INVENTION

The present invention relates to the Internet-based advertising system, and more particularly to a method and apparatus for downloading Internet advertisements in the Internet-based advertising system.

### BACKGROUND OF THE INVENTION

The Internet has been widely accepted as the fourth medium. After developing for many years, the Internet has become a rival to the traditional advertising media in respect of viewers and coverage. The Internet advertisement is superior to the traditional advertising media in such areas as one-to-one marketing and interactive services. However, due to the bandwidth limitation and the performance of network transmission, the Internet advertisement is inferior to the television medium in respect of ways of expression that can be used in brand promotion. Most medium web sites (such as www.sina.com.cn) adopt the following ways of delivering advertisements: embedding large scale “Flash” advertisements within web pages, or displaying large scale advertisements in new popup windows. The advertisements delivered in the above ways are simultaneously downloaded in the process of loading the web pages, which no doubt prolongs the time for displaying the web pages. Normally, the size of an Internet advertisement delivered in the prior advertising system is strictly restricted to about 20K bytes. No advertisements of larger sizes are allowed. Therefore, the ways of expression of Internet advertisements delivered in the prior advertising systems are limited. As a result, advertisers and advertisement agents cannot achieve the creative concepts they desire.

It is thus needed in the art to implement an Internet-based advertising system according to which large scale (for example 200K bytes or more) advertisements can be adequately delivered to the viewers and properly played without affecting viewers' surfing on the Internet.

### SUMMARY OF THE INVENTION

The objectives of the present invention are to meet the above need in the art and provide a method of downloading Internet advertisements, and an apparatus for downloading Internet advertisements.

In order to achieve the above objectives, the present invention provides a method of downloading Internet advertisement, comprising steps of:

downloading an Internet advertisement in a manner substantially unnoticeable to a user who browses a web page;

after said Internet advertisement is completely downloaded, playing said Internet advertisement to said user.

The present invention also provides an apparatus for downloading Internet advertisement, comprising:

means for downloading an Internet advertisement in a manner substantially unnoticeable to a user who browses a web page;

a player for playing said Internet advertisement to said user after said Internet advertisement is completely downloaded.

According to the present invention, Internet advertisements, especially large scale Internet advertisements (200K to 300K bytes, or more), can be downloaded in a manner substantially unnoticeable to the user, and the user's browsing activities (surfing) are not affected by the downloading of Internet advertisements.

Since the file size of the Internet advertisement is no longer restricted to 20 Kbytes, a lot of ways of expression become feasible in producing Internet advertisements. Thus the Internet advertisements delivered according to the present invention can achieve the same effects as traditional TV advertisements.

The apparatus or method of downloading Internet advertisements according to the present invention can be embedded in web pages along with which the Internet advertisements are scheduled to be delivered. It is not necessary for a user to additionally install any plug-ins.

Since the downloading of Internet advertisements is intelligently controlled so as to be adaptive to the changing bandwidth, it becomes possible and practical to deliver large scale Internet advertisements to narrow band users. This broadens the scope of viewers.

The apparatus and method of the present invention also apply to browsers that do not support Java applet.

In addition to Internet advertisements, other applications such as on-line games, on-line contests, on-line polls, etc. can be implemented in similar ways.

The format of the Internet advertisements is unlimited, which may be Flash, AVI, vrm1 (virtual reality), etc.

The container of the Internet advertisements is also unlimited, and may be a dialog box, a popup window, a banner, a floating window, an inline frame, etc. If an Internet advertisement is played in a dialog box, it will not be blocked by any tools of killing pop-up windows.

Other features and advantages of the present invention will be much clearer from the following description of the preferred embodiments, taken in conjunction with the accompanying drawings, which illustrate, byway of example, the principles of the invention.

### BRIEF DESCRIPTION OF THE DRAWINGS

FIG. 1 is a block diagram of the Internet-based advertising system according to the present invention;

FIG. 2 schematically shows one embodiment of the apparatus for downloading Internet advertisements according to the present invention;

FIG. 3 is a flow chart of one embodiment of the method of downloading Internet advertisements according to the present invention.

### DETAILED DESCRIPTION OF THE PREFERRED EMBODIMENT

The embodiments of the present invention will be described in detail.

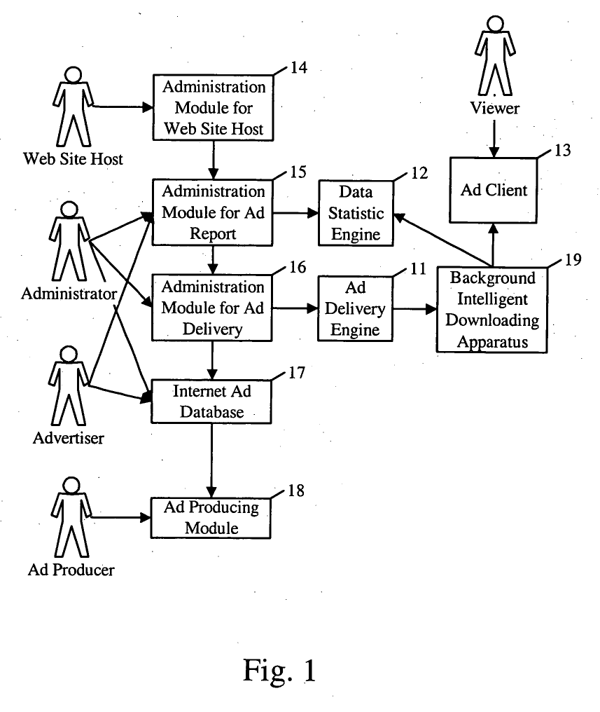

FIG. 1 is a block diagram of the Internet-based advertising system according to the present invention. As shown in FIG. 1, the Internet-based advertising system is composed of ad delivery engine 11, data statistic engine 12, ad client 13, administration module for ad report. 15, administration module for ad delivery 16, and background intelligent downloading apparatus 19.

Internet advertisements are delivered to users along with web pages. URLs of Internet advertisements are usually embedded in web pages. Ad delivery engine 11 is used to insert URLS of Internet advertisements to be delivered into web pages along with which the Internet advertisements are to be delivered. Alternatively, ad delivery engine 11 may also inserts Internet advertisement IDs into the web pages, and scripts in the web pages may translate Internet advertisement IDs into corresponding URLs of the Internet advertisements to be delivered.

Background intelligent downloading apparatus 19, also referred to as apparatus for downloading Internet advertisement, is described as follows.

Background intelligent downloading apparatus 19 comprises means for downloading an Internet advertisement into the cache of a browser in a manner substantially unnoticeable to a user who browses a web page, and a player for playing the downloaded Internet advertisement to the user after the Internet advertisement is completely downloaded.

When a user browses a web page along with which an Internet advertisement is scheduled to be delivered, the Internet advertisement is downloaded to the user's computer. And the downloading of the Internet advertisement is substantially unnoticeable to the user, even though the size of the Internet advertisement might be several hundred bytes, for example 200K to 300K bytes. Only after the Internet advertisement is completely downloaded to the user's computer does the player play the downloaded Internet advertisement to the user.

Two embodiments of background intelligent downloading apparatus 19 are given in the following.

The first embodiment of background intelligent downloading apparatus 19 is implemented as a piece of Java script codes embedded in the web page along with which the Internet advertisement is to be delivered. The first embodiment applies to browsers that do not support Java applet. Java script codes may automatically judge whether the browser support Java applet or not.

In the first embodiment, background intelligent downloading apparatus 19 further comprises means for opening a separate window independent of the web page. The Internet advertisement is to be downloaded in the separate window. The separate window is at least behind the window of the web page that is being browsed by the user. In so doing, the user's experience with the web page is not interrupted. After the Internet advertisement is completely downloaded, the separate window emerges from behind all windows in front of it, and the player plays the Internet advertisement in the separate window.

In above first embodiment, the separate window may be any container for advertisement such as a dialog box, a popup window, a banner, a floating window, an inline frame, etc. Different containers impose no restriction on the invention. Besides, shapes, colors, styles of the player also impose no restriction on the invention.

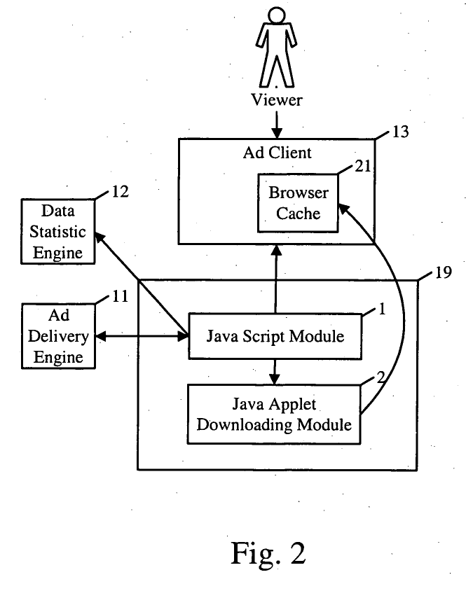

FIG. 2 schematically shows the second embodiment of the apparatus for downloading Internet advertisements (i.e., background intelligent downloading apparatus 19) according to the present invention.

The second embodiment of background intelligent downloading apparatus 19 is implemented as a piece of Java script codes and a Java applet embedded in the web page along with which the Internet advertisement is to be delivered. As shown in FIG. 2, background intelligent downloading apparatus 19 comprises Java script module 1 and Java applet downloading module 2.

Java script module 1 is used to receive from ad delivery engine 11 in FIG. 1 the file name (or URL, or ID) of the Internet advertisement to be delivered, and transfer to Java applet downloading module 2 the file name (or URL, or ID) of the Internet advertisement to be delivered. After the Internet advertisement is completely downloaded to the cache of the browser by Java applet downloading module 2, Java script module 1 controls a player (browser) to play the downloaded Internet advertisement, records the user's activities in viewing the Internet advertisement, such as viewing to the end of the advertisement, switching to the advertised web site, etc., and submits the recorded data to data statistic engine 12 shown in FIG. 1. Java script module 1 also communicates with Java applet downloading module 2, so as to control the playing time of more than two Internet advertisements, to control the number of times each Internet advertisement is played.

Java applet downloading module 2 is used to dynamically monitor the speed of the network connection of the user's computer, intelligently control the downloading of the Internet advertisement into the cache of the browser (browser cache 21), manage the queue of advertisements that have not been completely downloaded, manage the queue of advertisements that have been completely downloaded, and provide a status flag indicating completion when the downloading is finished.

Java applet downloading module 2 comprises:

means for downloading a first part (e.g., a first predetermined number of bytes) of the Internet advertisement into a browser cache; means for calculating the downloading bandwidth;

means for identifying the current connection which is either a wide band connection or a narrow band connection;

means for downloading a following part (a predetermined number of bytes, or a predetermined period of time)of the Internet advertisement in a way appropriate for the current connection.

Background intelligent downloading apparatus 19 may also comprises means for opening a separate window independent of the web page after the Internet advertisement is completely downloaded. The means for opening a separate window may be part of Java script module 1 or part of a browser. A player (browser) plays the Internet advertisement in the separate window after the Internet advertisement is completely downloaded.

In above second embodiment, the separate window may be any container for advertisement such as a dialog box, a popup window, a banner, a floating window, an inline frame, etc. Different containers impose no restriction on the invention. Besides, shapes, colors, styles of the player also impose no restriction on the invention.

The means for identifying the current connection identifies the current connection as a wide band connection if the downloading bandwidth is greater than a wide band threshold, or identifies the current connection as a narrow band connection if the downloading bandwidth is less than a narrow band threshold.

The means for downloading a following part of the Internet advertisement downloads the Internet advertisement for a second predetermined period, say one second, if the current connection is identified as a wide band connection, downloads a predetermined number of bytes of the Internet advertisement if the current connection is identified as a narrow band connection, or suspends for a first predetermined period if the downloading bandwidth is less than an idle threshold for a narrow band connection.

The following is an example of background intelligent downloading apparatus 19. It is implemented in a piece of Java script codes and Java applet. The Java script codes and Java applet are embedded in a web page along with which the Internet advertisement is to be delivered.

```
<!--icast [symbol] -->
<script language=“javascript”>
var icast_channel_ID=57;
if ( typeof(icast_channel_ID) != ‘number’ )
  icast_channel_ID = −1;
var_iCast_Controller_init=[icast_channel_ID, 42153,
  “http://ad4.sina.com.cn/bj-icast/mv/31/”,
  “http://ad4.sina.com.cn/bj-icast/skin/white/”,
  “http://ad4.sina.com.cn/forflash/flash/”, “”,
  “42153.swf”,
  “http://track.icast.com.cn/tracker/trackerI2.d
  11”, 400, 300, 240, 215, 0, “”, true, “#000000”,
  “42153.zip”];
document.write(‘<sc’+‘ript language=jscript.encode
  src=“http://ad4.sina.com.cn/bj-icast/mv/31/ica
  st.txt”><\/scr‘+’ipt>’);
</script>
```

In the above example, the URL of the Internet advertisement to be delivered is “http://ad4.sina.com.cn/bj-icast/mv/31/42153.swf”. The file name of the Internet advertisement is “42153.swf”. The URL or file name of the Internet advertisement are modified by ad delivery engine 11 shown in FIG. 1 depending on which Internet advertisement is to be delivered. Java applet downloading module 2 is included in “http://ad4.sina.com.cn/bj-icast/mv/31/icast.txt”. When a web page incorporating the above script codes is accessed by a browser, the Java applet will be downloaded into the user's computer, executed, and resides in the memory functioning as background intelligent downloading apparatus 19.

The following part of the specification mainly concerns the method of downloading Internet advertisements according to the present invention. The method of downloading Internet advertisement according to the present invention comprises the following steps:

downloading an Internet advertisement in a manner substantially unnoticeable to a user who browses a web page;

after the Internet advertisement is completely downloaded, playing the Internet advertisement to the user.

Two embodiments of the method of the present invention are described in the following.

The first embodiment of the method of downloading Internet advertisement is implemented as a piece of Java script codes embedded in the web page along with which the Internet advertisement is to be delivered.

In the first embodiment, the method of downloading Internet advertisements further comprises the following steps:

opening a separate window independent of the web page, wherein the Internet advertisement will be downloaded in the separate window;

causing the separate window emerge from behind all windows in front of it after the Internet advertisement is completely downloaded; and

playing the Internet advertisement in the separate window.

In above first embodiment, the separate window may be any container for advertisement such as a dialog box, a popup window, a banner, a floating window, an inline frame, etc. Different containers impose no restriction on the invention.

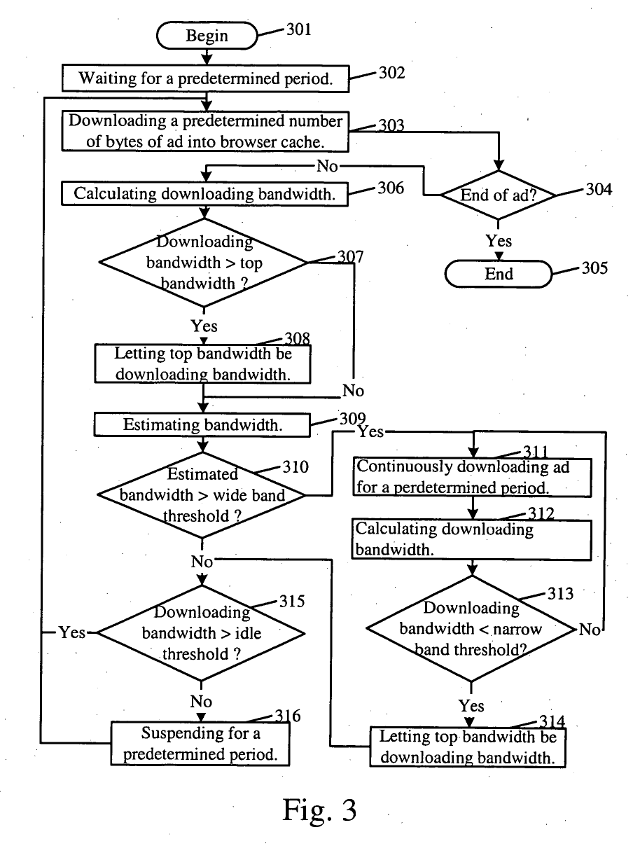

FIG. 3 is a flow chart of the second embodiment of the method of downloading Internet advertisements according to the present invention.

The second embodiment of the method of downloading Internet advertisements is implemented by a piece of Java script codes and a Java applet embedded in the web page along with which the Internet advertisement is to be delivered. FIG. 3 shows the main flow chart of the Java applet.

As shown in FIG. 3, the process begins at step 301. Then, at step 302, the process waits for a predetermined period of time, say five seconds, in order that the whole web page may be completely loaded into the browser cache.

Next, at step 303, the process downloads a predetermined number of bytes of Internet advertisement into the browser cache.

At step 304, it is decided whether the Internet advertisement has been completely downloaded. If the decision at step 304 is “yes”, the process goes to step 305; otherwise, to step 306.

At step 305, the downloading process ends. The control is then passed to Java script codes such that the downloaded Internet advertisement will be played.

At step 306, the downloading bandwidth is calculated.

At step 307, it is decided whether the downloading bandwidth is greater than the top bandwidth.

If the decision of step 307 is “no” the process goes to step 309; otherwise, to step 308.

At step 308, the value of the downloading bandwidth is assigned to the top bandwidth.

At step 309, a bandwidth is estimated based on the calculated bandwidth. For example, if the calculated downloading bandwidth is 48 kbps, the estimated bandwidth may be 56 kbps.

At step 310, it is decided whether the estimated bandwidth is greater than a wide band threshold. If the decision of step 310 is “yes”, the process goes to step 311; otherwise, to step 315.

At step 311, the Internet advertisement is continuously downloaded for a predetermined period of time, say several milliseconds.

At step 312, the downloading bandwidth is calculated.

At step 313, it is decided whether the downloading bandwidth is less than a narrow band threshold. If the decision of step 313 is “no”, the process goes to step 311; otherwise, to step 314.

At step 314, the value of the downloading bandwidth is assigned to the top bandwidth. Then, the process goes to step 315.

At step 315, it is decided whether the downloading bandwidth is greater than the idle threshold for the narrow band connection.

If the decision of step 315 is “no”, which means the network is busy, the process goes to step 316; otherwise to step 303.

At step 316, the process is suspended for a predetermined period of time, such that the browsing speed of the user is not affected. Then the process goes to step 303.

As concluded from FIG. 3, the step of downloading an Internet advertisement comprises the following steps:

downloading a first part of the Internet advertisement into a browser cache;

calculating downloading bandwidth;

identifying current connection which is either a wide band connection or a narrow band connection;

downloading a following part of the Internet advertisement in a way appropriate to the current connection.

The steps of calculating downloading bandwidth, identifying current connection, and downloading a following part of the Internet advertisement are repeated until the Internet advertisement is completely downloaded.

The method of downloading Internet advertisements according to the present invention may further comprises the following steps: opening a separate window independent of the web page after the Internet advertisement is completely downloaded; and playing the Internet advertisement in the separate window.

In above second embodiment, the separate window may be any container for advertisement such as a dialog box, a popup window, a banner, a floating window, an inline frame, etc. Different containers impose no restriction on the invention.

Also concluded from FIG. 3 is that the step of identifying current connection comprises steps of:

if the downloading bandwidth is greater than a wide band threshold, identifying the current connection as a wide band connection; and

if the downloading bandwidth is less than a narrow band threshold, identifying the current connection as a narrow band connection.

The step of downloading a following part of the Internet advertisement comprises steps of:

downloading the Internet advertisement for a second predetermined period if the current connection is identified as a wide band connection; and

downloading a predetermined number of bytes of the Internet advertisement if the current connection is identified as a narrow band connection.

The step of downloading a predetermined number of bytes of the Internet advertisement is suspended for a first predetermined period if the downloading bandwidth is less than an idle threshold.

While the foregoing has been with reference to specific embodiments of the invention, it will be appreciated by those skilled in the art that these are illustrations only and that changes in these embodiments can be made without departing from the principles of the invention, the scope of which is defined by the appended claims.

What is claimed is:

1. A method of downloading Internet advertisement, comprising steps of:
downloading an Internet advertisement in a manner substantially unnoticeable to a user who browses a web page;
after said Internet advertisement is completely downloaded, playing said Internet advertisement to said user.

2. The method according to claim 1, further comprising steps of:
opening a separate window independent of said web page, said Internet advertisement being downloaded in said separate window;
causing said separate window emerge from behind all windows in front of it after said Internet advertisement is completely downloaded; and
playing said Internet advertisement in said separate window.

3. The method according to claim 2, wherein said separate window is selected from a group consisting of a dialog box, a popup window, a banner, a floating window, and an inline frame.

4. The method according to claim 1, wherein said step of downloading an Internet advertisement comprises steps of:
downloading a first part of said Internet advertisement into a browser cache;
calculating downloading bandwidth;
identifying current connection which is either a wide band connection or a narrow band connection;
downloading a following part of said Internet advertisement in a way appropriate to said current connection.

5. The method according to claim 4, wherein said steps of calculating downloading bandwidth, identifying current connection, and downloading a following part of said Internet advertisement are repeated until said Internet advertisement is completely downloaded.

6. The method according to claim 5, further comprising steps of:
opening a separate window independent of said web page after said Internet advertisement is completely downloaded; and
playing said Internet advertisement in said separate window.

7. The method according to claim 6, wherein said separate window is selected from a group consisting of a dialog box, a popup window, a banner, a floating window, and an inline frame.

8. The method according to claim 5, wherein said step of identifying current connection comprises steps of:
if said downloading bandwidth is greater than a wide band threshold, identifying said current connection as a wide band connection; and
if said downloading bandwidth is less than a narrow band threshold, identifying said current connection as a narrow band connection.

9. The method according to claim 5, wherein said step of downloading a following part of said Internet advertisement comprises steps of:
downloading said Internet advertisement for a second predetermined period if said current connection is identified as a wide band connection; and
downloading a predetermined number of bytes of said Internet advertisement if said current connection is identified as a narrow band connection.

10. The method according to claim 9, wherein said step of downloading a predetermined number of bytes of said Internet advertisement is suspended for a first predetermined period if said downloading bandwidth is less than an idle threshold.

11. The method according to claim 5, wherein said steps of downloading a first part of said Internet advertisement, calculating downloading bandwidth, identifying current connection, and downloading a following part of said Internet advertisement are implemented in a Java applet embedded in said web page.

12. An apparatus for downloading Internet advertisement, comprising:
means for downloading an Internet advertisement in a manner substantially unnoticeable to a user who browses a web page;
a player for playing said Internet advertisement to said user after said Internet advertisement is completely downloaded.

13. The apparatus according to claim 12, further comprising: means for opening a separate window independent of said web page, wherein said Internet advertisement is to be downloaded in said separate window;
wherein said separate window emerges from behind all windows in front of it after said Internet advertisement is completely downloaded, and said player plays said Internet advertisement in said separate window.

14. The apparatus according to claim 13, wherein said separate window is selected from a group consisting of a dialog box, a popup window, a banner, a floating window, and an inline frame.

15. The apparatus according to claim 12, wherein said means for downloading an Internet advertisement comprises:
means for downloading a first part of said Internet advertisement into a browser cache;
means for calculating downloading bandwidth;
means for identifying current connection which is either a wide band connection or a narrow band connection;
means for downloading a following part of said Internet advertisement in a way appropriate for said current connection.

16. The apparatus according to claim 15, further comprising: means for opening a separate window independent of said web page after said Internet advertisement is completely downloaded, wherein said player plays said Internet advertisement in said separate window after said Internet advertisement is completely downloaded.

17. The apparatus according to claim 16, wherein said separate window is selected from a group consisting of a dialog box, a popup window, a banner, a floating window, and an inline frame.

18. The apparatus according to claim 15, wherein said means for identifying current connection identifies said current connection as a wide band connection if said downloading bandwidth is greater than a wide band threshold, and identifies said current connection as a narrow band connection if said downloading bandwidth is less than a narrow band threshold.

19. The apparatus according to claim 15, wherein said means for downloading a following part of said Internet advertisement downloads said Internet advertisement for a second predetermined period if said current connection is identified as a wide band connection, downloads a predetermined number of bytes of said Internet advertisement if said current connection is identified as a narrow band connection, suspends for a first predetermined period if said downloading bandwidth is less than an idle threshold for a narrow band connection.

20. The apparatus according to claim 15, wherein said means for downloading a first part of said Internet advertisement, calculating downloading bandwidth, identifying current connection, and downloading a following part of said Internet advertisement are implemented as a Java applet embedded in said web page.
